(19) United States
(12) Patent Application Publication
(10) Pub. No.: US 2016/0153306 A1
(43) Pub. Date: Jun. 2, 2016

(54) RADIAL POSITION CONTROL OF CASE SUPPORT STRUCTURE WITH SPLINED CONNECTION

(71) Applicant: UNITED TECHNOLOGIES CORPORATION, Hartford, CT (US)

(72) Inventors: Dmitrity A. Romanov, Wells, ME (US); Brian Duguay, Berwick, ME (US)

(21) Appl. No.: 14/904,621

(22) PCT Filed: Jun. 18, 2014
(86) PCT No.: PCT/US2014/042840

§ 371 Date: Jan. 12, 2016

Related U.S. Application Data
(60) Provisional application No. 61/857,412, filed on Jul. 23, 2013.

(51) Int. Cl. F01D 11/18; F02C 7/20; F01D 25/28

(52) U.S. Cl. CPC F01D 11/18; F01D 25/28; F02C 7/20; F05D 2240/55

(57) ABSTRACT

A radial position control assembly for a gas turbine engine includes a case structure. A support structure is operatively supported by the case structure respectively with first and second splines in engagement with one another. The support structure includes an annular recess, and a support ring is received in the recess. The support structure and the support ring having different coefficients of thermal expansion. An axial biasing member urges the first and second splines into engagement with one another.

### CROSS-REFERENCE TO RELATED APPLICATIONS

This application claims priority to United States Provisional Application No. 61/857,412, which was filed on Jul. 23, 2013.

### STATEMENT REGARDING FEDERALLY SPONSORED RESEARCH OR DEVELOPMENT

This invention was made with government support under Contract No. FA8650-09-D-2923 0021 awarded by the United States Air Force. The Government has certain rights in this invention.

### BACKGROUND

This disclosure relates to a gas turbine engine having a case, for example, for a compressor or turbine section of the engine. More particularly, the disclosure relates to controlling the radial position of a structure supported by the case during thermal transients.

Multiple fixed and rotatable stages are arranged within the case of the engine's static structure. Typically, support structure, such as stators and blade outer air seals, are fastened to the case. Radial clearances must be provided between the stators, blade outer air seals and adjacent sealing structure of rotating structure, such as rotors and blades. Since the support structure and case are in close proximity to and affixed relative to one another, the support structure thermally responds to the bulk case temperature. Thus, during temperature transients the support structure may move radially inward more than desired, which may cause a rub event.

To avoid rub events, the designed radial clearances between the static and rotating structure are enlarged. During generally steady-state temperatures, the clearances are larger than necessary, which reduces the efficiency of the stage during cruise conditions, for example.

One radial clearance control system uses a support ring that supports a blade outer air seal (BOAS) and/or a stator via a support structure. The support ring and support structure are constructed from materials of different coefficients of thermal expansion, which better maintains desired running clearance during thermal transients. The support structure is typically segmented and arranged circumferentially about an axis. The segments are designed to “lock up” and form a continuous ring of material in some conditions. As the segments expand during engine operation, some of the segments may bind, preventing uniform lock up of the segments.

### SUMMARY

In one exemplary embodiment, a radial position control assembly for a gas turbine engine includes a case structure. A support structure is operatively supported by the case structure respectively with first and second splines in engagement with one another. The support structure includes an annular recess, and a support ring is received in the recess. The support structure and the support ring having different coefficients of thermal expansion. An axial biasing member urges the first and second splines into engagement with one another.

In a further embodiment of any of the above, the first and second splines include beveled surfaces that slidably engage one another, the axial biasing member and the first and second splines on opposing axial sides of the support structure.

In a further embodiment of any of the above, the support structure includes first and second portions that provide the recess and are secured about the support ring.

In a further embodiment of any of the above, a sealing structure is adjacent to the support structure. The support ring maintains the support structure relative to the sealing structure at a radial clearance during thermal transients based upon a circumferential gap between adjacent support structure and based upon a radial gap between the support ring and the support structure.

In a further embodiment of any of the above, the support structure is a blade outer air seal. The sealing structure is a blade.

In a further embodiment of any of the above, the case structure is a compressor case. The support structure is an outer platform of a vane.

In a further embodiment of any of the above, the coefficient of thermal expansion of the support ring is less than the coefficient of thermal expansion of the support structure. The support ring is a continuous circumferentially unbroken annular structure.

In a further embodiment of any of the above, the support ring includes first and second states. The support structure includes expanded and contracted positions in each of the first and second states of the support ring. The circumferential gap is about zero in the expanded state. The circumferential gap is greater than zero in the contracted state. The support ring is enlarged in the second state with respect to the first state. The support structure and the support ring respectively include first and second surfaces that are radially adjacent to one another to provide the radial gap. The radial gap is about zero in first and fourth conditions, the first condition with the support ring in the first state and the support structure contracted, and the fourth condition with the support ring in the second state and the support structure contracted. The radial gap is greater than zero in second and third conditions, the second condition with the support ring in the first state and the support structure expanded, and the third condition with the support ring in the second state and the support structure expanded.

In a further embodiment of any of the above, the first condition corresponds to a cold condition. The second condition corresponds to a warm condition. The third condition corresponds to a hot condition. The fourth condition corresponds to a rapid deceleration condition from the hot condition.

In a further embodiment of any of the above, a radial biasing member is arranged between the case structure and the support structure and provides a radial biasing force to the support structure.

In another exemplary embodiment, a gas turbine engine includes a compressor section. A combustor is fluidly connected downstream from the compressor section. A turbine section is fluidly connected downstream from the combustor. A case structure is disposed about the compressor section, the combustor and the turbine section. A support structure has multiple segments operatively supported by the case structure respectively with first and second splines engaging one another. The support structure includes an annular recess. A support ring is received in the recess. The support structure and the support ring have different coefficients of thermal expansion. A sealing structure is adjacent to the support structure. The support ring maintains the support structure relative to the sealing structure at a radial clearance during thermal transients based upon a circumferential gap between adjacent support structure segments and based upon a radial gap between the support ring and the support structure. An axial biasing member urges the first and second splines into engagement with one another while accommodating misalignment between the first and second splines from non-uniform circumferential gaps between the segments.

In a further embodiment of any of the above, the first and second splines include beveled surfaces that slidably engage one another.

In a further embodiment of any of the above, the support structure includes first and second portions that provide the recess and are secured about the support ring.

In a further embodiment of any of the above, the support structure is a blade outer air seal. The sealing structure is a blade.

In a further embodiment of any of the above, the case structure is a compressor case. The support structure is an outer platform of a vane.

In a further embodiment of any of the above, the coefficient of thermal expansion of the support ring is less than the coefficient of thermal expansion of the support structure. The support ring is a continuous circumferentially unbroken annular structure.

In a further embodiment of any of the above, the support ring includes first and second states. The support structure includes expanded and contracted positions in each of the first and second states of the support ring. The circumferential gap is about zero in the expanded state and the circumferential gap is greater than zero in the contracted state. The support ring is enlarged in the second state with respect to the first state. The support structure and support ring respectively include first and second surfaces that are radially adjacent to one another to provide the radial gap. The radial gap is about zero in first and fourth conditions, the first condition with the support ring in the first state and the support structure contracted, and the fourth condition with the support ring in the second state and the support structure contracted. The radial gap is greater than zero in second and third conditions, the second condition with the support ring in the first state and the support structure expanded, and the third condition with the support ring in the second state and the support structure expanded.

In a further embodiment of any of the above, the first condition corresponds to a cold condition. The second condition corresponds to a warm condition. The third condition corresponds to a hot condition. The fourth condition corresponds to a rapid deceleration condition from the hot condition.

In a further embodiment of any of the above, a radial biasing member is arranged between the case structure and the support structure and provides a radial biasing force to the support structure.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2A is a schematic view of a section of the engine illustrating both fixed and rotatable stages.

FIG. 2B is a schematic view depicting circumferentially adjacent support structures having a circumferential gap.

FIG. 2C depicts the support structures of FIG. 2B without the circumferential gap.

FIG. 3A schematically depicts a first condition corresponding to a support ring in a first state and a support structure in a contracted position.

FIG. 3B schematically depicts a second condition corresponding to the support ring in the first state and the support structure in an expanded position.

FIG. 3C schematically depicts a third condition corresponding to the support ring in a second state and the support structure in an expanded condition.

FIG. 3D schematically depicts a fourth condition corresponding to the support ring in the second state and the support structure in the contracted position.

FIG. 4 illustrates a circumferentially continuous, unbroken support ring.

FIG. 5 schematically depicts a support structure and the support ring used to support a BOAS.

FIG. 6 is an end view of a circumferential portion of the support structure shown in FIG. 5.

FIG. 7A is a cross-sectional view of a splined engagement taken along line 7A-7A of FIG. 5 in a seated position.

FIG. 7B illustrates the splined engagement in an unseated position.

FIG. 8 is a schematic view of support structure and support ring used to support a stator vane.

### DETAILED DESCRIPTION

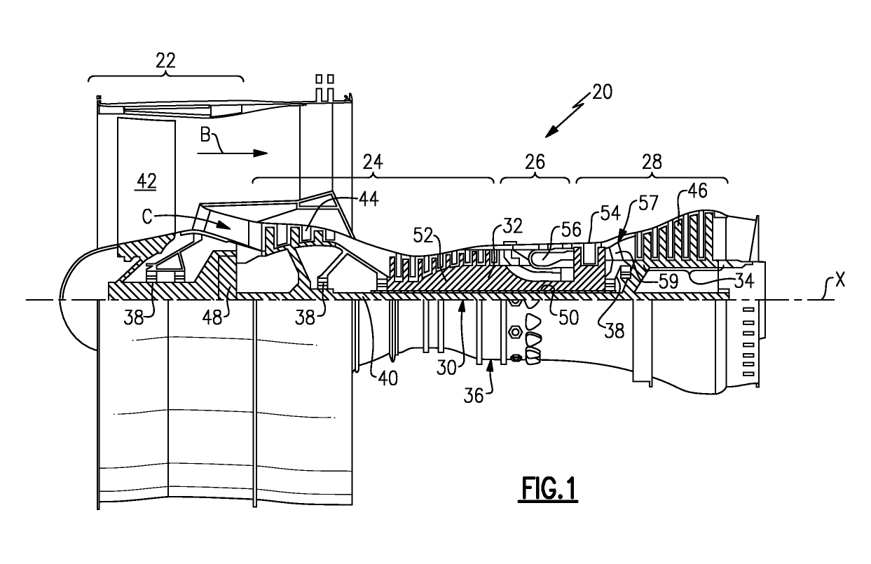

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis X.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram° R)/518.7]^{0.5}. The “Low corrected fan tip speed”, as disclosed herein according to one non-limiting embodiment, is less than about 1150 ft/second.

FIG. 2A illustrates a section 60 of the engine 10. The section 60 includes a case structure 62 of the engine static structure 36. The case structure 62 includes a fixed stage 64 and a rotatable stage 66. The fixed stage 64 includes an array of stator vanes, and the rotatable stage 66 includes an array of blades 72 mounted on a rotor 74 rotatable about the axis X. In the fixed stage, a support structure 68, such as an outer platform of one or more vanes, is operatively supported by the case structure 62. An inner diameter of the vanes seals relative to rotatable structure, such a rotor. In the rotatable stage 66, a support structure 70, such as a blade outer air seal (BOAS), is operatively supported by the case structure 62. It is desirable that the desired radial clearance within the fixed stage and rotatable stage 64, 66 is minimal to maintain high operating efficiency through the section 60 during various operating conditions and transients. A typical desired clearance between the support structure and the adjacent sealing structure is 0.000-0.010 inch (0.00-0.25 mm) at cruise.

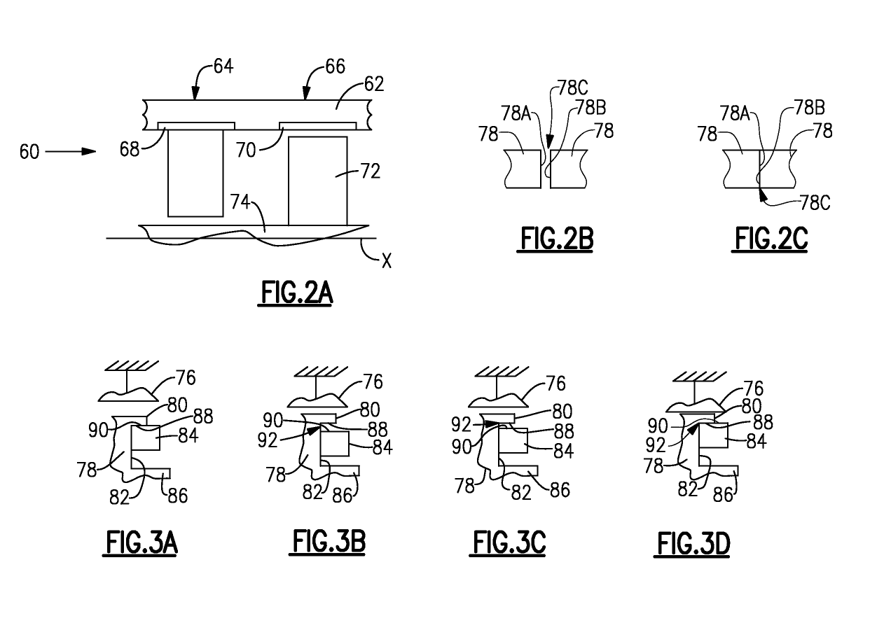

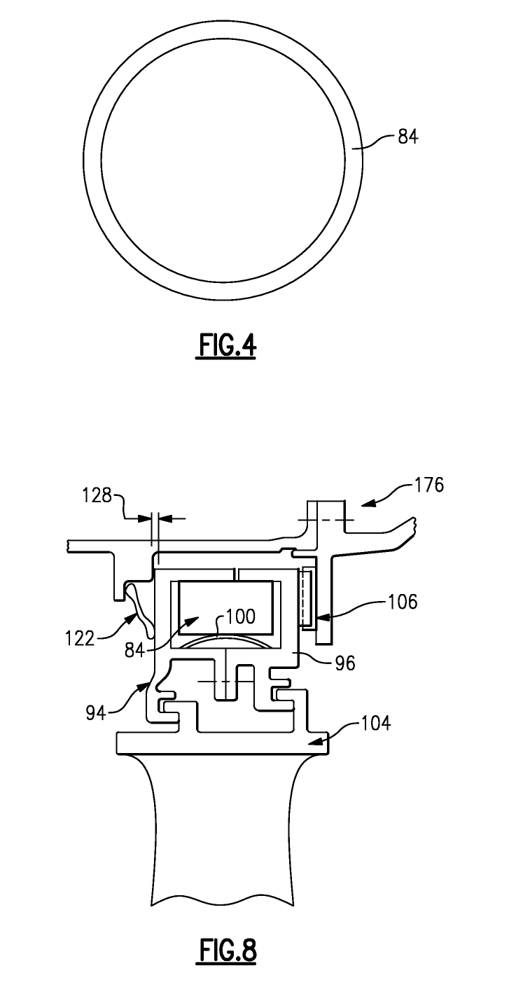

To this end, a radial position control system is used to regulate the radial position of support structure 78 relative to the case structure 76, as illustrated in a greatly simplified manner in FIGS. 3A-3D. These support structures 78 include at least one hook or surface 80, which defines an annular recess or pocket 82 that opens to a lateral side of the support structure. A support ring 84 is received within the recess 82. In the example, the support ring is a continuous, unbroken structure about its circumference (e.g., support ring 84, FIG. 4). However, this is not to say that the support ring 84 cannot be formed by a multiple segments. Rather, the support ring 84 should be provided by a continuous structure such that the structure cannot circumferentially uncouple about its circumference. That is, the support ring 84 should expand and contract as a single unitary structure.

The support structure 78 and the support ring 84 have different coefficients of thermal expansion (CTE). The support ring 84 has a lower CTE than the support structure 78 such that the support structure 78 expands and contracts more quickly than the support ring 84. In this manner, the support ring 84 is more dimensionally stable during thermal transients. In one example, the support ring 84 is a ceramic matrix composite or a metal alloy, and the support structure 78 is a ceramic matrix composite, metal alloy or monolithic ceramic.

The support structure 78 supports a member 86, which may be a stator vane (104 in FIG. 8) or blade outer air seal (102 in FIG. 5), for example. It is desirable to control the radial position of member 86 during thermal transients. The difference in coefficients of thermal expansion between the support structure 78 and the support ring 84 controls the radial position of the member 86 relative to its adjacent sealing structure.

Referring to FIG. 3A-3B, the first and second surfaces 88, 90 are respectively provided by the hook 80 and the support ring 84. The first and second surfaces 88, 90 are radially adjacent to and engageable with one another during certain conditions, discussed below. Referring to FIG. 2B, the first and second surfaces 78A and 78B of the circumferentially adjacent support structures 78 create a gap 78C, and are engageable with one another during certain conditions discussed below.

Referring to FIGS. 3A-3B, the support ring 84 is illustrated in a first state, which is at a lower temperature and contracted compared to a second state (shown in FIG. 3C-3D). With continuing reference to FIG. 3A, the support structure 78 is shown in a first condition (cold) in which the first and second surfaces 88, 90 are contacting one another, eliminating the gap 92. Surfaces 78A and 78B are not in contact providing gap 78C, best shown in FIG. 2B. In this condition, the support ring 84 is loaded.

As the support structure 78 expands more rapidly than the support ring 84, the member 86 will move to the second condition (warm), shown in FIG. 3B, During the heating process, a point occurs where the support structure 78 increases in temperature and expands, and the circumferential growth of support structure 78 increases to a point when the gap 78C is reduced to zero, best shown in FIG. 2C. Up to this point, the support structure 78 is still loading support ring 84. This transient point in heating of support structure 78 is called the “lock-up” point. In this transient condition, between the first condition and the second condition, the first and second surfaces 88, 90 are still engaged with one another but the support ring 84 is no longer loaded.

With the gap 78C reduced to zero, any further heating of support structure 78, will cause its circumference to grow as if they were made as a solid, full ring structure. Since the support structure 78 has a higher CTE than the support ring 84 any further heating of the support structure 78 will result in the gap 92 to increase from zero. When the support structure 78 reaches the second condition, the circumferential growth of the support structure 78 has increased to the point where the gap 92 is large, and the support ring 84 is unloaded. Eventually during sustained high temperatures, the support ring 84 will expand, providing an enlarged diameter or second state relative to the first state, as shown in FIG. 3C, which corresponds to the third condition (hot). It should be understood the terms “cold,” “warm,” and “hot” are intended to be relative terms. Since the first and second surfaces 88, 90 are disengaged with one another; the expanded support ring 84 will not control the radial position of the support structure 78.

Referring to FIG. 3D, during a rapid cool down, such as a rapid deceleration, the support structure 78, which has a higher CTE, will more rapidly contract than the support ring 84. During the cool down transition, the circumferential length of support structure 78 decreases until the circumferential length at gap 92 equals the circumference of the support ring 84. At this point the support structure 78 has cooled enough that the gap 92 has closed, and the gap 78C begins to open, this transient point is known as “unlock”. In this condition, the support ring 84 is starts to become loaded. As cooling continues the gap 78C get larger, and the radial position of the support structure 78 is controlled by the support ring 84. Beneficially, the support ring 84, which has a lower CTE, will remain generally in the second state, which prevents the support structure 78 from moving too far radially inward. Thus, during the cool down the support structure 78 is controlled by a slower cooling and different growth rate support ring 84.

When the support ring 84 is in the second state, and the support structure 78 is cooling back to the first state, the support structure 78 is held at a larger radial position. Thus, if a re-heating event was to occur at this time, quickly raising the support structure back to the second state, it will already be partially in a larger radial position.

One example implementation of the arrangements shown in FIGS. 3A-3D is illustrated in FIGS. 5-7B. The arrangement may be used in the compressor section or the turbine section.

Referring to the example shown in FIG. 5, the support structure 78 includes first and second portions 94, 96 secured to one another to provide a cavity 98. The support ring 84 is arranged within the cavity 98. A biasing member 100 urges the support ring 84 radially with respect to the support structure 78.

The supported member 86 illustrated in FIGS. 3A-3D may be a variety of structures depending upon the application within the gas turbine engine. For example, the member 86 may be used in a rotating stage, in which case the member corresponds to a blade outer air seal (BOAS) 102. The member 86 may be provided in a non-rotating stage, in which case the member corresponds to a stator vane 104, as shown in FIG. 8.

A splined engagement 106 is provided operatively between the support structure 78 and the case structure 76. In one example, the splined engagement 106 provides first and second radial splines 108, 110 that engage one another to radially locate the support structure 78 with respect to the case structure 76. The splined engagement 106 permits the support structure 78 to move radially with respect to the case structure during engine component expansion and contraction.

The first spline 108 is provided on the second portion 96. In the example illustrated in FIG. 5, a separate case portion 112 provides the second spline 110. Alternatively, the second spline 110 may be provided by a structure that is integral with a portion of the case structure 76 (FIG. 8).

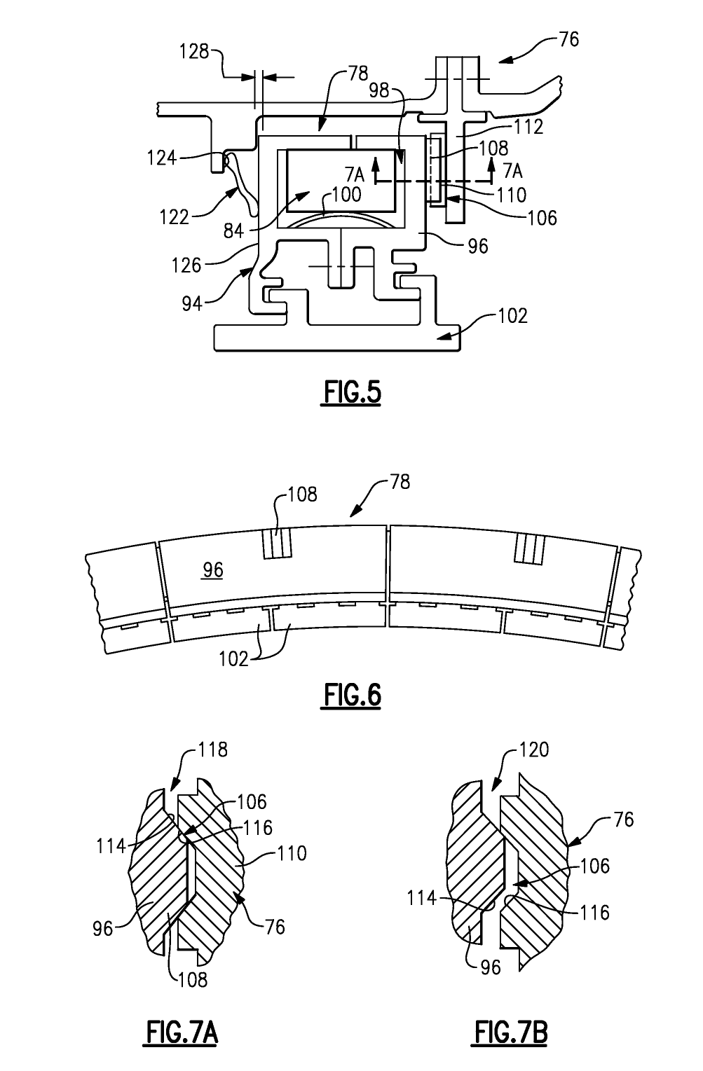

An axial biasing member 122 is arranged between the case structure 76 and the support structure 78. The case structure 76 includes a seat 124 that cooperates with a portion of the axial biasing member 122, which engages a surface 126 of the first portion 94. The axial biasing member 122 urges the first and second radial splines 108, 110 into engagement with one another, yet permits the splines to move circumferentially and axially relative to one another during misalignments between the segments, shown in FIG. 6, during “lock-up.”

Referring to FIG. 6, the support structure 78 is provided by multiple arcuate segments circumferentially spaced about the axis X (shown in FIG. 1). In one example, at least three sets of first and second radial splines 108, 110 are used for the support structure 78. In the example shown in FIG. 6, a radial spline is provided on each segment.

Referring to FIGS. 7A and 7B, the first and second radial splines 108, 110 respectively include first and second beveled faces 114, 116 that may engage and disengage one another due to misalignments between components during engine operation. FIG. 7A illustrates the first and second splines 108, 110 in a seated position 118 when the components are aligned as desired. The first and second splines 108, 110 may become unseated with respect to one another in an unseated position 120, as shown in FIG. 7B, as some segments circumferentially engage one another while others do not yet circumferentially engage one another. As a result, uniform lock-up of the support structure segments can occur, and damage to the radial control position assembly can be avoided.

Although an example embodiment has been disclosed, a worker of ordinary skill in this art would recognize that certain modifications would come within the scope of the claims. For that reason, the following claims should be studied to determine their true scope and content.

What is claimed is:

1. A radial position control assembly for a gas turbine engine comprising:
a case structure;
a support structure operatively supported by the case structure respectively with first and second splines engaging one another, the support structure including an annular recess;
a support ring received in the recess, the support structure and the support ring having different coefficients of thermal expansion; and
an axial biasing member urging the first and second splines into engagement with one another.

2. The radial position control assembly according to claim 1, wherein the first and second splines include beveled surfaces that slidably engage one another, the axial biasing member and the first and second splines on opposing axial sides of the support structure.

3. The radial position control assembly according to claim 1, wherein the support structure includes first and second portions providing the recess and secured about the support ring.

4. The radial position control assembly according to claim 1, comprising a sealing structure adjacent to the support structure, the support ring maintaining the support structure relative to the sealing structure at a radial clearance during thermal transients based upon a circumferential gap between adjacent support structure and based upon a radial gap between the support ring and the support structure.

5. The radial position control assembly according to claim 4, wherein the support structure is a blade outer air seal and the sealing structure is a blade.

6. The radial position control assembly according to claim 4, wherein the case structure is a compressor case, and the support structure is an outer platform of a vane.

7. The radial position control assembly according to claim 4, wherein the coefficient of thermal expansion of the support ring is less than the coefficient of thermal expansion of the support structure, and the support ring is a continuous circumferentially unbroken annular structure.

8. The radial position control assembly according to claim 7, wherein the support ring includes first and second states, and the support structure includes expanded and contracted positions in each of the first and second states of the support ring, wherein the circumferential gap is about zero in the expanded state and the circumferential gap is greater than zero in the contracted state, wherein the support ring is enlarged in the second state with respect to the first state, the support structure and support ring respectively include first and second surfaces that are radially adjacent to one another to provide the radial gap, and the radial gap is about zero in first and fourth conditions, the first condition with the support ring in the first state and the support structure contracted, and the fourth condition with the support ring in the second state and the support structure contracted, the radial gap greater than zero in second and third conditions, the second condition with the support ring in the first state and the support structure expanded, and the third condition with the support ring in the second state and the support structure expanded.

9. The radial position control assembly according to claim 8, wherein the first condition corresponds to a cold condition, the second condition corresponds to a warm condition, the third condition corresponds to a hot condition, and the fourth condition corresponds to a rapid deceleration condition from the hot condition.

10. The radial position control assembly according to claim 1, comprising a radial biasing member arranged between the case structure and the support structure providing a radial biasing force to the support structure.

11. A gas turbine engine comprising:
a compressor section;
a combustor fluidly connected downstream from the compressor section;
a turbine section fluidly connected downstream from the combustor;
a case structure disposed about the compressor section, the combustor and the turbine section;
a support structure having multiple segments operatively supported by the case structure respectively with first and second splines engaging one another, the support structure including an annular recess;
a support ring received in the recess, the support structure and the support ring having different coefficients of thermal expansion;
a sealing structure adjacent to the support structure, the support ring maintaining the support structure relative to the sealing structure at a radial clearance during thermal transients based upon a circumferential gap between adjacent support structure segments and based upon a radial gap between the support ring and the support structure; and
an axial biasing member urging the first and second splines into engagement with one another while accommodating misalignment between the first and second splines from non-uniform circumferential gaps between the segments.

12. The gas turbine engine according to claim 11, wherein the first and second splines include beveled surfaces that slidably engage one another.

13. The gas turbine engine according to claim 11, wherein the support structure includes first and second portions providing the recess and secured about the support ring.

14. The gas turbine engine according to claim 11, wherein the support structure is a blade outer air seal and the sealing structure is a blade.

15. The gas turbine engine according to claim 11, wherein the case structure is a compressor case, and the support structure is an outer platform of a vane.

16. The gas turbine engine according to claim 11, wherein the coefficient of thermal expansion of the support ring is less than the coefficient of thermal expansion of the support structure, and the support ring is a continuous circumferentially unbroken annular structure.

17. The gas turbine engine according to claim 16, wherein the support ring includes first and second states, and the support structure includes expanded and contracted positions in each of the first and second states of the support ring, wherein the circumferential gap is about zero in the expanded state and the circumferential gap is greater than zero in the contracted state, wherein the support ring is enlarged in the second state with respect to the first state, the support structure and support ring respectively include first and second surfaces that are radially adjacent to one another to provide the radial gap, and the radial gap is about zero in first and fourth conditions, the first condition with the support ring in the first state and the support structure contracted, and the fourth condition with the support ring in the second state and the support structure contracted, the radial gap greater than zero in second and third conditions, the second condition with the support ring in the first state and the support structure expanded, and the third condition with the support ring in the second state and the support structure expanded.

18. The gas turbine engine according to claim 17, wherein the first condition corresponds to a cold condition, the second condition corresponds to a warm condition, the third condition corresponds to a hot condition, and the fourth condition corresponds to a rapid deceleration condition from the hot condition.

19. The gas turbine engine according to claim 11, comprising a radial biasing member arranged between the case structure and the support structure providing a radial biasing force to the support structure.
